(19) United States
(12) Patent Application Publication
(10) Pub. No.: US 2026/0080108 A1
(43) Pub. Date: Mar. 19, 2026

(54) HARDWARE ENCRYPTION MODULE, CHIP AND ENCRYPTION METHOD

(71) Applicant: CRM ICBG (WUXI) CO., LTD., Wuxi (CN)

(72) Inventors: Jun SUN, Wuxi (CN); Jiajun CHEN, Wuxi (CN); Tianping SHEN, Wuxi (CN); Jiamin GUO, Wuxi (CN)

(73) Assignee: CRM ICBG (WUXI) CO., LTD., Wuxi (CN)

(21) Appl. No.: 18/994,076

(22) PCT Filed: Aug. 16, 2023
(86) PCT No.: PCT/CN2023/113292

§ 371 Date: Nov. 30, 2025

(30) Foreign Application Priority Data
Sep. 1, 2022 (CN) 202211067892.8

(51) Int. Cl. G06F 21/79

(52) U.S. Cl. CPC G06F 21/79

(57) ABSTRACT

A hardware encryption module, a chip and an encryption method. The hardware encryption module comprising a control unit and a storage unit; the control unit is connected to the storage unit, receives external instructions, determines an encryption status based on an encryption indicator in an encryption bit address of the storage unit, generates a first control timing sequence for controlling erase of the storage unit based on an external erase instruction, and generates a second control timing sequence for controlling reading/writing of the storage unit based on the encryption status and an external read/write instruction; when in an encrypted mode, only the program area is encrypted against reading, and writing operations to the encryption bit address are prohibited. All encryption behaviors of the present disclosure are effective only for the program area and are not effective for the data area.

### FIELD OF THE INVENTION

The present disclosure relates to the field of integrated circuit design, and in particular relates to a hardware encryption module, a chip and an encryption method.

### BACKGROUND OF THE INVENTION

In recent years, as the concept of information security has gained widespread attention, the encryption function of chips has become an increasingly important method for users to protect their product data.

Software encryption methods are widely used due to their simplicity of implementation. Typically, software encryption involves adding an encryption identifier at a fixed position in the chip's storage area. If the encryption identifier is validated, the programmer either does not perform the read action and directly returns an encrypted value, or it still reads but returns the encrypted value. However, such encryption is very easy to crack, has low security, and also suffers from slow speed and high storage resource usage.

Hardware encryption offers fast encryption speed, good hardware security, no storage resource usage, and ease of use. It effectively compensates for the shortcomings of software encryption methods, better protecting the software intellectual property within the chip and reducing the risk of being copied.

Therefore, enhancing the security of hardware encryption has become one of the key technical challenges in this field.

It should be noted that the above introduction to the technical background is only provided to facilitate a clear and complete explanation of the technical solutions of the present disclosure and to aid the understanding of technical personnel in this field. It cannot be assumed that the above-mentioned technical solutions are known to those skilled in the art merely because they are set forth in the background section of the present disclosure.

### SUMMARY OF THE INVENTION

The present disclosure provides a hardware encryption module, a chip and an encryption method, to address the issue of insufficient hardware encryption security in related technologies.

The presently disclosed hardware encryption module includes:

a control unit and a storage unit, wherein the storage unit comprises a program area and a data area;

the control unit is connected to the storage unit, receives external instructions, determines an encryption status based on an encryption indicator in an encryption bit address of the storage unit, generates a first control timing sequence for controlling erase of the storage unit based on an external erase instruction, and generates a second control timing sequence for controlling reading or writing of the storage unit based on the encryption status and an external read/write instruction; wherein, when in an encrypted mode, only the program area is encrypted against reading, and writing operations to the encryption bit address are prohibited.

Optionally, the control unit comprises an instruction parsing subunit and a timing sequence generation subunit;

the instruction parsing subunit is connected to the timing sequence generation subunit, generates a program-area-erase control signal or a data-area-erase control signal based on the external erase instruction, and generates a read/write control signal based on the encryption status and the external read/write instruction;

the timing sequence generation subunit is connected to the storage unit and the instruction parsing subunit, determines the encryption status based on the encryption indicator in the encryption bit address, and generates the first and second control timing sequences of the storage unit based on control signals output from the instruction parsing subunit.

Optionally, the instruction parsing subunit comprises an address judgment section and a control signal generation section;

the address judgment section judges an address in the external read/write instruction to obtain a judgment result;

the control signal generation section is connected to outputs of the address judgment section and the timing sequence generation subunit to generate an internal erase control signal based on the external erase instruction, and to generate an internal read/write control signal based on the external read/write instruction, the judgment result of the address judgment section, and the encryption status.

Optionally, the timing sequence generation subunit includes an encryption status judgment section and a control timing sequence generation section;

the encryption status judgment section is connected to the storage unit to judge the encryption status based on a comparison result between the encryption indicator in the encryption bit address and a preset value;

the control timing sequence generation section is connected to an output of the instruction parsing subunit, and generates the first and second control timing sequences of the storage unit based on the control signals output from the instruction parsing subunit.

Optionally, the data area comprises a TRIM area and a user area.

Optionally, the encryption bit address is located in the program area.

Optionally, the encryption bit address is located at a bottom of the program area.

The chip includes a hardware encryption module as described above.

The encryption method includes:

obtaining an encryption indicator in an encryption bit address after powering on, judging and updating an encryption status based on the encryption indicator in the encryption bit address;

in response to receiving an external erase instruction, generating a program-area-erase control signal or a data-area-erase control signal based on the external erase instruction, entirely erasing a program area of a storage unit based on the program-area-erase control signal or entirely erasing a data area of the storage unit based on the data-area-erase control signal;

in response to receiving an external write instruction, judging the encryption status and a write address at which a write operation is to be performed, and prohibiting writing if the write address is the encryption bit address and the encryption status is an encrypted mode; otherwise, the write operation is performed on the write address in the storage unit based on the external write instruction;

in response to receiving an external read instruction, judging the encryption status and a read address at which a read operation is to be performed, and if the read address is located in the program area and the encryption status is the encrypted mode, reading an encrypted value in the read address; otherwise reading an actual value in the read address based on the external read instruction.

Optionally, the encryption bit address is located in the program area.

Optionally, the method of judging the encryption status comprises: comparing a value of the encryption indicator in the encryption bit address with a preset value, and if the two match, the encryption status is the encrypted mode, otherwise the encryption status is the decrypted mode.

As described above, the hardware encryption module, chip and encryption method of the present disclosure have the following beneficial effects:
1. In the presently disclosed hardware encryption module, chip and encryption method, there are two types of erase methods in an erase mode: program area erasing and data area erasing, which simplifies the operation process while meeting user scenarios; additionally, the encryption bit address is set in the program area, so when the user erases the encryption bit, the entire program must be erased, preventing forced decryption by erasing the encryption bit alone.
2. In a write mode, the encryption status and write address are first judged, and in an encrypted mode, users cannot write to the encryption bit address, preventing forced decryption by rewriting the encryption bit data.
3. In a read mode, the encryption status and read address are judged; the data area is not affected by the encryption status, and its correct data can be read at any time; the program area can be read correctly in a decrypted mode, otherwise an encrypted value in the corresponding address is read.
4. In the present disclosure, the super reading mode is discarded (a super reading mode is when the program area and the data area can be read correctly whether they are in an encrypted mode or not), effectively improving the security of the chip.
5. The present disclosures allow all programming instructions (or protocols) to be made public, which facilitates users in developing their own programming tools, greatly enhancing the product's application flexibility; at the same time, the rigorous encryption logic can effectively protect the software in the program area, minimizing the possibility of decryption and unauthorized reading.

### BRIEF DESCRIPTION OF DRAWINGS

FIG. 1 shows a schematic structural diagram of a hardware encryption module according to an embodiment of the present disclosure.

FIG. 2 shows a schematic structural diagram of a hardware encryption module according to another embodiment of the present disclosure

FIG. 3 shows a schematic structural diagram of an instruction parsing subunit of the present disclosure.

FIG. 4 shows a schematic structural diagram of a timing sequence generation subunit of the present disclosure.

FIG. 5 shows a schematic diagram showing an exemplary principle of an encryption method of the present disclosure.

### REFERENCE NUMERALS

1 Hardware encryption device
11 Control section
111 Instruction parsing unit
112 Timing sequence generation unit
12 Memory section
121 Program area
122 TRIM area
123 User area
2 Hardware encryption module
21 Control unit
211 Instruction parsing subunit
211a Address judgment section
211b Control signal generation section
212 Timing sequence generation subunit
212a Encryption status judgment section
212b Control timing sequence generation section
22 Memory unit
221 Program area
222 Data area
222a TRIM area
222b User area

### DETAILED DESCRIPTION

The embodiments of the present disclosure will be described below. Those skilled can easily understand advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure.

Refer to FIG. 1 to FIG. 5. It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components'layout may also be more complicated.

FIG. 1 shows a hardware encryption device 1 of an embodiment of the present disclosure, comprising a control section 11 and a memory section 12. The control section 11 comprises an instruction parsing unit 111 and a timing sequence generation unit 112, wherein the instruction parsing unit 111 parses external input instructions, the timing sequence generation unit 112 generates a control timing sequence of the memory section 12 based on signals output by the instruction parsing unit 111; for example, the timing sequence generation unit 112 generates a first control timing sequence for controlling erase of a storage unit (e.g., the memory Attorney section 12) based on an external erase instruction, and generates a second control timing sequence for controlling reading or writing of the storage unit based on the encryption status and an external read or write instruction. The memory section 12 is divided into a program area 121, a TRIM area 122 and a user area 123, and an encryption bit address is allocated in the TRIM area 122.

Immediately after the powering on of the chip, the hardware (i.e., the control section 11) will read an encryption value in the encryption bit address and make a determination, if the encryption value in the encryption bit address corresponds to a predetermined value set by the hardware at the time of the design, the chip is in an encrypted mode, otherwise the chip is in a default decrypted mode. In executing an erase instruction of the memory section 12, the timing sequence generation unit 112 generates a corresponding timing sequence to erase an address of the memory section 12 (any address of the memory section 12 is available for erasure). In executing a write instruction of the memory section 12, the timing sequence generation unit 112 generates a corresponding timing sequence to write to an address of the memory section 12 (any address of the memory section 12 is available for writing). When executing a read instruction, the memory section 12 can operate in either a normal mode or a super mode; in the normal mode, data read from the memory section 12 is restricted by the encryption status, when the chip is in the decrypted mode data in any address of the memory section 12 can be read normally, when the chip is in the encrypted mode data in any address of the memory section 12 cannot be read normally; in the super mode, data in any address of the memory section 12 can be read correctly regardless of the chip's encryption status; entering super mode requires an external special command; this mode is mainly designed to meet the special scenario needs where users still need to access the TRIM area 122 or the user area 123 when the chip is encrypted.

However, the hardware encryption device 1 has the following problems during operation: 1) Users can directly erase the encryption value in the encryption bit address and re-power up the chip, thereby realizing forced decryption of the chip. 2) Users can rewrite the encryption bit data by rewriting the encryption bit address and powering up the chip, thus realizing forced decryption of the chip. 3) There is still a chance of obtaining a special instruction to enter the super mode through analyzing input signals of the chip, leading to a risk of information leakage. 4) The programming instructions (or protocols) of the hardware encryption device 1 cannot be made public (if made public, the encryption function would be rendered useless, allowing programming and reading of the software code in the program area), thus preventing users from developing software and hardware for the chip.

To enhance the security and flexibility of the hardware encryption device 1 mentioned in the previous embodiment, another embodiment of the present disclosure proposes a hardware encryption module, chip, and encryption method.

The specific solution is detailed below.

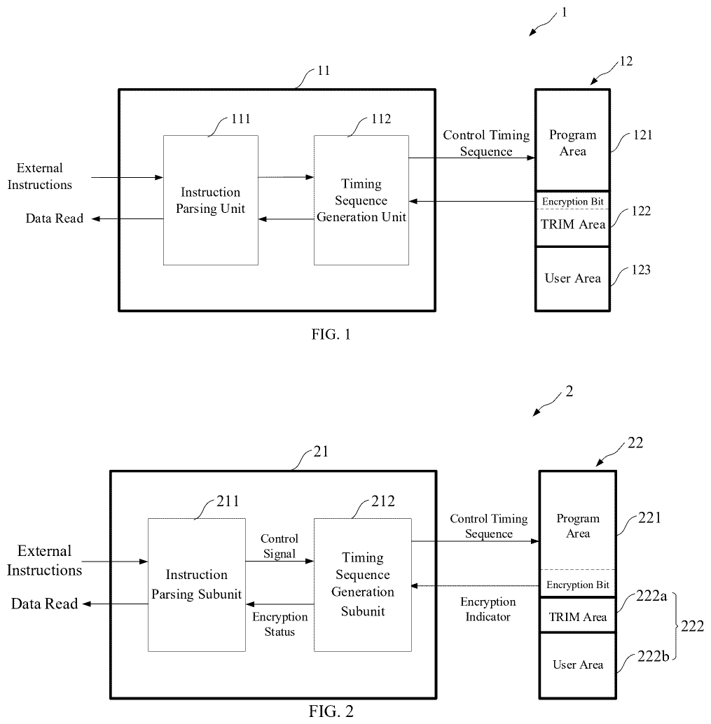

As shown in FIG. 2, the present disclosure provides a hardware encryption module 2, comprising:

a control unit 21 and a storage unit 22, wherein the storage unit 22 comprises a program area 221 and a data area 222.

As shown in FIG. 2, the control unit 21 is connected to the storage unit 22, receives external instructions, determines an encryption status based on an encryption indicator in an encryption bit address of the storage unit 22, generates a first control timing sequence for controlling erase of the storage unit 22 based on an external erase instruction, and generates a second control timing sequence for controlling reading/writing of the storage unit 22 based on the encryption status and an external read/write instruction; wherein, when in an encrypted mode, only the program area is encrypted against reading, and writing operations to the encryption bit address are prohibited.

Specifically, as an example, the external instructions include an external erase instruction, an external write instruction, and an external read instruction; the external erase instruction contains an erase area (program area or data area) and erase operation information; the external write instruction contains write addresses and write operation information; the external read instruction contains read addresses and read operation information.

Specifically, as an example, the control unit 21 comprises an instruction parsing subunit 211 and a timing sequence generation subunit 212. The instruction parsing subunit 211 is connected to the timing sequence generation subunit 212, generates a program-area-erase control signal or a data-area-erase control signal based on the external erase instruction, and generates read/write control signals (write control signal, read control signal) based on the encryption status and the external read/write instructions (i.e., the external write instruction, and external read instruction). The timing sequence generation subunit 212 is connected to the storage unit 22 and the instruction parsing subunit 211; the timing sequence generation subunit 212 determines the encryption status of the storage unit based on an encryption indicator in the encryption bit address after powering on, records the encryption status or updates the recorded encryption status, and generates the control timing sequences of the storage unit 22 based on control signals output from the instruction parsing subunit 211.

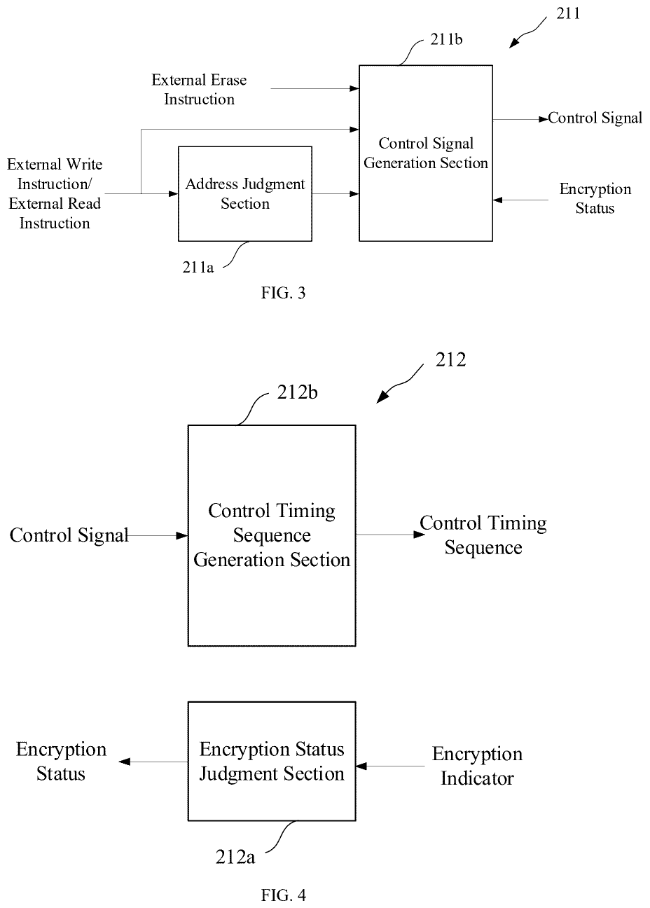

More specifically, as shown in FIG. 3, as an example, the instruction parsing subunit 211 includes an address judgment section 211a and a control signal generation section 211b. The address judgment section 211a judges the address in the external read/write instruction to determine whether the address in the external read/write instruction to be executed for writing or reading is located in the program area 221 or data area 222, and outputs a corresponding judgment signal. The control signal generation section 211b is connected to outputs of the address judgment section 211a and the timing sequence generation subunit 212 to generate an erase control signal based on the external erase instruction; the erase control signal is a program-area-erase control signal or a data-area-erase control signal; the program-area-erase control signal is used to entirely erase the program area 221, and the data-area-erase control signal is used to entirely erase the data area 222, i.e., the erase operation can only be performed on the entire area of the program area 221 or the data area 222, and cannot be performed only on some addresses.

The control signal generation section 211b also generates a corresponding read/write control signal based on the external read/write instruction, the judgment signal of the address judgment section 211a, and the encryption status.

More specifically, as shown in FIG. 4, as an example, the timing sequence generation subunit 212 includes an encryption status judgment section 212a and a control timing sequence generation section 212b. The encryption status judgment section 212a is connected to the storage unit 22, judges the encryption status based on the comparison result between the encryption indicator in the encryption bit address and a preset value, and when the encryption indicator in the encryption bit address matches (equals or satisfies a predetermined relationship with) the preset value, the storage unit 22 is determined to be in the encrypted mode, otherwise the storage unit 22 is determined to be in the decrypted mode; then the encryption status judgment section 212a outputs a corresponding encryption status signal and feeds it back to the instruction parsing subunit 211. The control timing sequence generation section 212b is connected to an output of the instruction parsing subunit 211 and generates the first and second control timing sequences of the storage unit 22 based on the control signals (the erase control signal, write control signal, or read control signal) output from the instruction parsing subunit 211, thereby accomplishing the read, write, and erase operations of the storage unit 22.

It is to be noted that the encryption status judgment section 212a may be provided in the instruction parsing subunit 211 or independently in the control unit 21 as desired.

As shown in FIG. 2, the storage unit 22 is controlled by the control unit 21, and is for storing programs and data.

Specifically, as an example, the storage unit 22 is a flash memory. In practice, any type of memory that can realize the storage unit of the present disclosure is applicable herein.

Specifically, the storage unit 22 is divided into a program area 221 and a data area 222. Further, as an example, the data area 222 is divided into a TRIM area 222a and a user area 222b. The program area 221 is used for storing user-developed programs, the TRIM area 222a is used for storing calibration data from the chip manufacturer, and the user area 222b is used for storing user-defined data. In practice, the data area 222 may be divided into different areas as required to realize specific storage functions.

Specifically, as an example, the encryption bit address is located in the program area 221, in which case erasing the encryption indicator in the encryption bit address requires simultaneously erasing other information within the program area 221. Even if decryption is achieved, the information in the program area will no longer exist, thus preventing access to the information (including but not limited to program code) in the program area 221. This further reduces the risk of information leakage and enhances security. More specifically, since the program code must be continuous and cannot be interrupted, to maximize the storage space of the program area 221, the encryption bit address is set at the bottom of the program area 221, which is the last part to be written. In practice, if the space occupied by each unit of the program code can be determined, the encryption bit address can be set at any position within the program area 221 without affecting the operation of the program code.

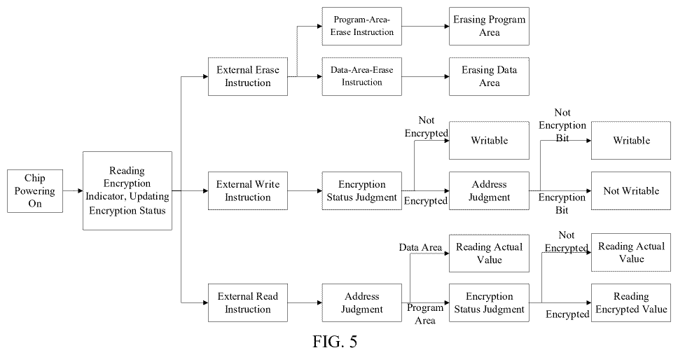

As shown in FIG. 5, the present disclosure also provides an encryption method. As an example, the encryption method is realized based on the hardware encryption module 2. However, any hardware capable of realizing the method in practice is suitable for the present disclosure. The encryption method comprises:
1) obtaining an encryption indicator in an encryption bit address after powering on, judging and updating an encryption status based on the encryption indicator in the encryption bit address;

Specifically, after powering on, the encryption indicator in the encryption bit address of the storage unit 22 is read by the control unit 21, and the encryption indicator in the encryption bit address is compared with a predetermined value, and if the two match (equal or satisfy a predetermined relationship), it indicates that the storage unit is in an encrypted mode, and otherwise in an decrypted mode; then the control unit 21 generates a corresponding encryption status signal.

More specifically, as an example, the judgment of the encryption status is accomplished by the timing sequence generation subunit 212, and in practice, any circuit capable of judging the encryption status based on the encryption indicator in the encryption bit address is applicable to the present disclosure.

The method further includes: 21) in response to receiving an external erase instruction, generating a program-area-erase control signal or a data-area-erase control signal based on the external erase instruction, and entirely erasing a program area 221 of the storage unit based on the program-area-erase control signal or entirely erasing a data area 222 of the storage unit based on the data-area-erase control signal.

Specifically, when the external instruction is an erase instruction, the external instruction contains an erase area and erase operation information, then, the control unit 21 generates a program-area-erase control signal or a data-area-erase control signal based on the external instruction; if a program-area-erase control signal is generated, the program area 221 is erased based on the corresponding control timing sequence; if a data-area-erase control signal is generated, the data area 222 is erased based on the corresponding control timing sequence.

Specifically, in the present disclosure, in the erase mode, only two types of erase methods are allowed, which comprise program area erasing and data area erasing. The program area erasing erases all and only program area addresses, and the data area erasing erases all and only data in a TRIM area 222a and a user area 222b; users cannot arbitrarily set the address to erase; this design simplifies the operation process while satisfying users'needs. As an implementation of the present disclosure, the encryption bit address of the present disclosure is located in the program area 221 (further, at the bottom of the program area 221), so that users must erase all of the program while erasing the encryption bit, preventing a forced decryption caused by erasing the encryption bit alone.

The method further comprises: 22) in response to receiving an external write instruction, judging the encryption status and a write address at which a write operation is to be performed, and prohibiting writing if the write address is the encryption bit address and the encryption status is an encrypted mode; otherwise performing the write operation on the write address in the storage unit 22 based on the external write instruction;

More specifically, when the external instruction is a write instruction, the encryption status and the write address are judged respectively. As an example, judgment is first made on the encryption status, and when in the decrypted mode, a write operation is carried out on the write address in the storage unit 22 (whether in the program area or the data area) based on the external write instruction; when in the encrypted mode, further judgment is made on the write address, and if the write address is the encryption bit address, the write operation is prohibited, and if the write address is not the encryption bit address, the write operation is performed on the write address in the storage unit 22 (whether the program area or the data area) based on the external write instruction.

It should be noted that, in practice, there is no fixed sequence of encryption status judgment and address judgment, and address judgment can also be carried out before encryption status judgment, or encryption status judgment and address judgment at the same time, as long as the judgment results can be finally obtained, and the corresponding control signals generated.

To sum it up, in the write mode, the encryption status and the write address are respectively judged, and the user cannot perform a write operation on the encryption bit address in the encrypted mode, in order to prevent forcible decryption by rewriting the encryption bit data.

The method further includes: 23) in response to receiving an external read instruction, judging the encryption status and a read address at which a read operation is to be performed, and if the read address is located in the program area 221 and the encryption status is the encrypted mode, reading an encrypted value in the read address; otherwise reading an actual value in the read address based on the external read instruction.

Specifically, when the external instruction is a read instruction, the encryption status and the read address are respectively judged. As an example, the read address is first judged, and if the read address is located in the data area 222, a read operation is carried out on the corresponding address in the data area 222 based on the external read instruction to obtain the corresponding actual value; if the read address is located in the program area 221, further judgment is made on the encryption status, and if it is in the decrypted mode then the read operation is performed on the corresponding address in the program area 221 based on the external read instruction, thereby acquiring the corresponding actual value, and if it is in the encrypted mode then the read operation is performed on the corresponding address in the program area 221 based on the external read instruction, thereby acquiring the corresponding encrypted value.

It should be noted that, in practice, the encryption status judgment and the address judgment do not have a fixed order; that is, the encryption status judgment can also be carried out before the address judgment, or the encryption status judgment and the address judgment are carried out at the same time, as long as the judgment results can be finally obtained, and corresponding control signals generated.

To sum it up, in the read mode, the encryption status and the read address are respectively judged; the data area is not affected by the encryption status and the correct data can be read at any time; the program area can be read correctly in the decrypted mode, and its encrypted value in the corresponding address is read in the encrypted mode. The present disclosure discards the super reading mode, thereby effectively improving the security of the chip. The present disclosures allow all programming instructions (or protocols) to be made public, which facilitates users in developing their own programming tools, greatly enhancing the product's application flexibility; meanwhile, the program area is encrypted, minimizing the possibility of decryption and unauthorized reading.

The present disclosure also provides a chip, the chip comprising a hardware encryption module 2 used to realize encrypted protection of the chip. In practice, any electronic product requiring encrypted protection can adopt the hardware encryption module 2 of the present disclosure.

In summary, the present disclosure provides a hardware encryption module, a chip and an encryption method. The hardware encryption module comprises a control unit and a storage unit comprising a program area and a data area; the control unit is connected to the storage unit, receives external instructions, determines an encryption status based on an encryption indicator in an encryption bit address of the storage unit, generates a first control timing sequence for controlling erase of the storage unit based on an external erase instruction, and generates a second control timing sequence for controlling reading/writing of the storage unit based on the encryption status and an external read/write instruction; wherein, when in an encrypted mode, only the program area is encrypted against reading, and writing operations to the encryption bit address are prohibited. In the presently disclosed hardware encryption module, chip, and encryption method, programs are the main focus for protection, and all encryption behaviors of the present disclosure are effective only for the program area and are not effective for the data area; the partitioned management of the storage unit enables users to have realize access to the data area in the encrypted mode. The present disclosure prevents users from forcibly decrypting the encryption bit address by directly erasing the encryption bit address and re-powering up; the present disclosure prevents users from forcibly decrypting the encryption bit address by rewriting the encryption bit address and re-powering up; the present disclosure discards the super reading mode, thereby effectively improving the security of the chip; and the presently disclosed product has high application flexibility and high security. Therefore, the present disclosure effectively overcomes various shortcomings in the existing technology and has high industrial utilization value.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall be still covered by the claims of the present disclosure.

1. A hardware encryption module, comprising:
a control unit and a storage unit, wherein the storage unit comprises a program area and a data area;
the control unit is connected to the storage unit, receives external instructions, determines an encryption status based on an encryption indicator in an encryption bit address of the storage unit, generates a first control timing sequence for controlling erase of the storage unit based on an external erase instruction, and generates a second control timing sequence for controlling reading or writing of the storage unit based on the encryption status and an external read or write instruction; wherein, when in an encrypted mode, only the program area is encrypted against reading, and writing operations to the encryption bit address are prohibited.

2. The hardware encryption module according to claim 1, wherein the control unit comprises an instruction parsing subunit and a timing sequence generation subunit;
the instruction parsing subunit is connected to the timing sequence generation subunit, generates a program-area-erase control signal or a data-area-erase control signal based on the external erase instruction, and generates a read or write control signal based on the encryption status and the external read or write instruction;
the timing sequence generation subunit is connected to the storage unit and the instruction parsing subunit, determines the encryption status based on the encryption indicator in the encryption bit address, and generates the first and second control timing sequences of the storage unit based on control signals output from the instruction parsing subunit.

3. The hardware encryption module according to claim 2, wherein the instruction parsing subunit comprises an address judgment section and a control signal generation section;
the address judgment section judges an address in the external read or write instruction to obtain a judgment result;
the control signal generation section is connected to outputs of the address judgment section and the timing sequence generation subunit to generate an internal erase control signal based on the external erase instruction, and to generate an internal read or write control signal based on the external read or write instruction, the judgment result of the address judgment section, and the encryption status.

4. The hardware encryption module according to claim 2, wherein the timing sequence generation subunit comprises an encryption status judgment section and a control timing sequence generation section;
the encryption status judgment section is connected to the storage unit to judge the encryption status based on a comparison result between the encryption indicator in the encryption bit address and a preset value;
the control timing sequence generation section is connected to an output of the instruction parsing subunit, and generates the first and second control timing sequences of the storage unit based on the control signals output from the instruction parsing subunit.

5. The hardware encryption module according to claim 1, wherein the data area comprises a TRIM area and a user area.

6. The hardware encryption module according to any one of claims 1-5, wherein the encryption bit address is located in the program area.

7. The hardware encryption module according to claim 6, wherein the encryption bit address is located at a bottom of the program area.

8. A chip, comprising a hardware encryption module as claimed in any one of claims 1-7.

9. An encryption method, comprising:
1) obtaining an encryption indicator in an encryption bit address after powering on, judging and updating an encryption status based on the encryption indicator in the encryption bit address;
in response to receiving an external erase instruction, generating a program-area-erase control signal or a data-area-erase control signal based on the external erase instruction, entirely erasing a program area of a storage unit based on the program-area-erase control signal or entirely erasing a data area of the storage unit based on the data-area-erase control signal;
in response to receiving an external write instruction, judging the encryption status and a write address at which a write operation is to be performed, and prohibiting writing if the write address is the encryption bit address and the encryption status is an encrypted mode; otherwise, performing the write operation on the write address in the storage unit based on the external write instruction;
in response to receiving an external read instruction, judging the encryption status and a read address at which a read operation is to be performed, and if the read address is located in the program area and the encryption status is the encrypted mode, reading an encrypted value in the read address; otherwise reading an actual value in the read address in the storage unit based on the external read instruction.

10. The encryption method according to claim 9, wherein the encryption bit address is located in the program area.

11. The encryption method according to claim 9 or 10, wherein the method of judging the encryption status comprises: comparing a value of the encryption indicator in the encryption bit address with a preset value, and if the two match, the encryption status is the encrypted mode, otherwise the encryption status is a decrypted mode.

12. The encryption method according to claim 9, wherein in an erase mode, only two types of erase methods are allowed, which comprise program area erasing and data area erasing; wherein the program area erasing erases all and only program area addresses, and the data area erasing erases all and only data in a TRIM area and a user area.

13. The encryption method according to claim 9, wherein the encryption status is judged when the external write instruction is received, and if the encryption status is the decrypted mode, the write operation is performed based on the external write instruction on the write address in the program area or the data area of the storage unit.

14. The encryption method according to claim 13, wherein when the external read instruction is received:
if the read address is located in the data area, the read operation is performed on the read address in the data area based on the external read instruction to obtain the actual value in the read address;
if the read address is located in the program area, the encryption status is then judged:
if in the decrypted mode, the read operation is performed on the read address in the program area based on the external read instruction to obtain the actual value in the read address;
if in the encrypted mode, the read operation is performed on the read address in the program area based on the external read instruction to obtain the encrypted value in the read address.

15. The encryption method according to claim 9, wherein the external erase instruction comprises an erase area and erase operation information; the external write instruction comprises the write address and write operation information; and the external read instruction comprises the read address and read operation information.
